(19) United States
(12) Patent Application Publication
(10) Pub. No.: US 2014/0033602 A1
(43) Pub. Date: Feb. 6, 2014

(54) ADJUSTABLE FISH HOOK HOLDER

(71) Applicant: John Gesik, Ada, MI (US)

(72) Inventor: John Gesik, Ada, MI (US)

(21) Appl. No.: 13/955,289

(22) Filed: Jul. 31, 2013

Related U.S. Application Data
(60) Provisional application No. 61/678,797, filed on Aug. 2, 2012.

(51) Int. Cl. A01K 97/06

(52) U.S. Cl. CPC A01K 97/06
USPC 43/57.1

(57) ABSTRACT

A fishing lure holder includes an L-shaped frame carrying magnets spaced-apart for releasably magnetically retaining the hooks of the lures. The magnetic field of the magnets extends through the frame, such that the apparatus self-attaches to any magnetically-responsive material, such as the side wall of a boat, a floor or a compartment lid's underside. Advantageously, the holders can be removed, adjusted, and repositioned repeatedly to virtually any orientation or spacing. This allows placement to provide a correct spacing that will allow multiple treble hooks on a lure to be secured by the exposed magnets. A post prevents lateral slip-off of a single hook from individual magnets, thus adding additional safety and security to the system. A tackle box includes slots that can releasably receive the base plate with magnetic lure holders thereon, or receive the holders directly.

This application claims benefit under 35 USC §119(e) of provisional application Ser. No. 61/678,797, filed Aug. 2, 2012, entitled ADJUSTABLE FISH HOOK HOLDER, the entire contents of which are incorporated herein by reference.

### BACKGROUND OF THE INVENTION

The present invention relates to fish hook and lure holders, and more particularly relates to an adjustable fish hook/lure holder having the ability to adjust to optimally support and safely hold the hooks of different lures in different orientations, regardless of size, shape, number of hook barbs, and the like.

Fishermen often change lures. Thus, they are always looking for additional storage options for their lures. One common storage tactic is to use multiple utility boxes that hold up to 20-40 lures each. However, the utility boxes often require multiple snaps to open. Further, this makes it very difficult to determine what lures are in each box at a glance. Also, lures get tangled, causing frustration and loss of fish time. Most anglers would like to keep a multitude of lures ready and within reach, but they also want to be able to return lures to a safe organized location. However, by their nature, the lures snag and their hooks become tangled very quickly.

### SUMMARY OF THE INVENTION

A fishing lure holder apparatus is provided for attachment to a metal surface, such as to a base plate, such as a fishing boat hull, or under a lid on compartment, or on console and/or on a boat floor. The present holder apparatus preferably includes an angled section of material with magnets attached on at least one side for releasably holding fishing lure hooks. The magnets are exposed and spaced apart, allowing the lure's hooks to attach and detach with amazing safety and convenience. The magnetic field of the magnets also extends through the angled section, making it useful for attaching the angled section to a metal base plate, or for direct attachment to a metal boat hull. The magnet retention allows the holder to be removed and/or repositioned for personal convenience and preference, which is a great advantage.

In a narrower form, pairs of the holder apparatus are used and selectively spaced so that their spacing creates a specific dimension that accommodates multiple hooks on one lure. This overcomes a problem in that, as lures are all different lengths and sizes, a fixed two units might accommodate the correct spacing for only one size lure.

In another aspect of the present invention, a fishing lure holder apparatus includes a section of material with spaced apart magnets on at least one of its sides, the magnets being located slightly inboard from an edge of the section. The magnets are designed to allow the lure's hooks to attach and detach for safety and convenience. A post extends from an angled section at a location between at least one of the magnets and the adjacent edge of the holder, the post having a tip that extends at least as high as a top surface of the magnets. By this arrangement, a fish hook held on the selected magnet cannot laterally slip off the top surface without engaging the tip. For single hooked lures such as spinner baits and large jigs, the small post provides a catch for engaging the bend of the hook, thus preventing accidental release.

An object of the present invention is to provide lure storage on various places on a boat, such as to a side of the boat, to a console, console lid, or to the underside of a compartment lid or boat component, so that the lures are visible and easily accessible in seconds, yet the lures do not tangle or snag things undesirably.

An object of the present invention is to provide a magnetic lure holder permitting quick and easy selection and release, as well as providing a post that prevents lures from accidentally laterally sliding off of a particular magnet.

These and other features, advantages, and objects of the present invention will be further understood and appreciated by those skilled in the art by reference to the following specification, claims, and appended drawings.

### BRIEF DESCRIPTION OF THE DRAWINGS

FIG. 1 is a perspective view of the present fishing lure holder apparatus attached to a metal base plate, such as a boat hull or other boat component.

FIGS. 2-3 are side and end views of a pair of the angled sections shown in FIG. 1.

FIGS. 4-9 are drawings showing various positions of a pair of the angled sections, FIG. 4 being on a vertical surface with vertical orientation and horizontal spacing, FIG. 5 being on a vertical surface with horizontal orientation and vertical spacing, FIG. 6 showing readjustment of one of the pair of angled sections, FIG. 7 being on an under a horizontal surface, FIG. 8 being on a vertical surface, FIG. 9 being on top of a horizontal surface.

FIG. 10 is an end view showing a modified fishing lure holder with its angled section attached to a vertical surface, and with a single fish hook engaging a magnet with a small post preventing the single fish hook from sliding off the magnet laterally.

FIG. 11 is a perspective view of the modified fishing lure holder apparatus in FIG. 10.

FIG. 12 is a front view of another modified fishing lure holder apparatus, where the holder is secured to a base plate by hook-and-loop material, such as Velcro®, instead of by magnetic force.

FIG. 12A is a view of a modified fishing lure holder apparatus like FIG. 12, but where two spaced-apart strips of hook-and-loop material are used to selectively mount a lure-holder with magnets therein.

FIG. 13 is an enlarged view of the hook-and-loop material of FIGS. 12 and 12A, including the base plate and the lure holder apparatus.

FIG. 14 is a side view of FIG. 13.

FIG. 15 is a perspective view of a tackle box including slots at each end for receiving a base plate with the present lure holding apparatus attached thereto.

FIG. 16 is a top view showing the tackle box of FIG. 15 with the base plate and lure holding apparatus positioned in the slots.

FIG. 17 is a side view orthogonal to FIG. 16, which shows the base plate and lure holding apparatus, but also shows a lure holding apparatus supported directly in a pair of the slots in the tackle box.

### DETAILED DESCRIPTION

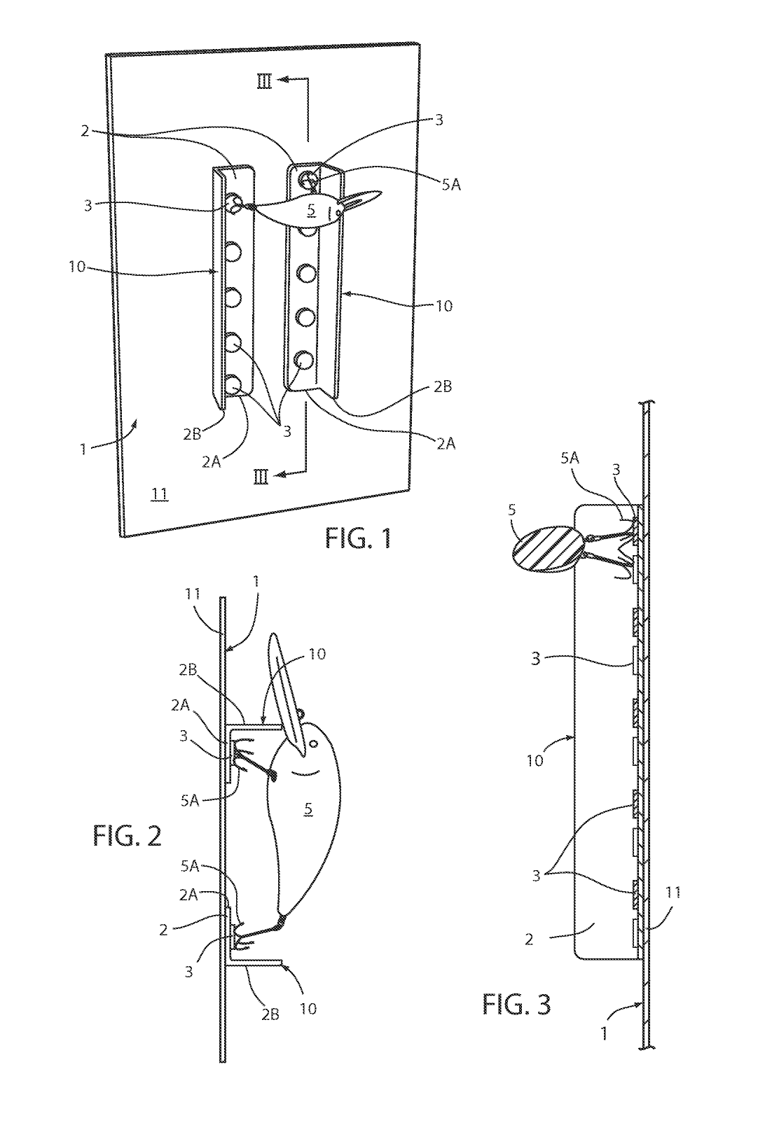

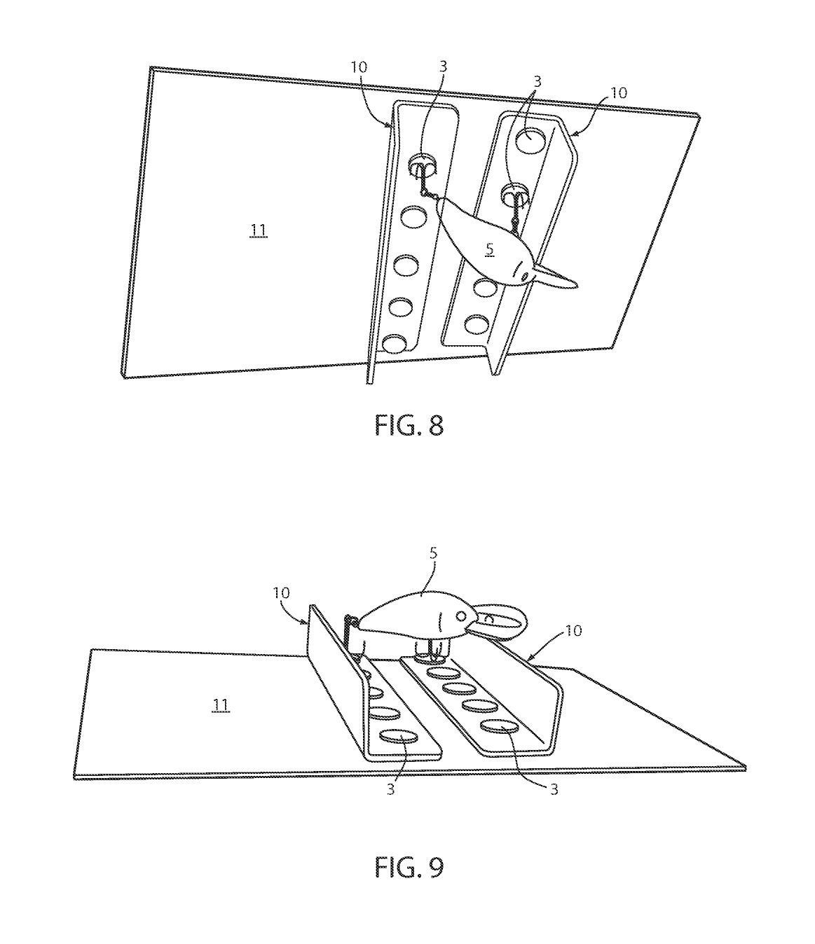

A fishing lure holder apparatus 10 (FIGS. 1-11) is provided for attachment in a convenient location to a support having a magnetically-responsive surface, such as to a separate base plate 11, or to a magnetically-responsive base 1 forming part of a fishing boat hull, (or forming part of a compartment, console, floor, or seat, or under a lid for a compartment on the boat).

In the present discussion and following claims, the phrase “base plate” is intended to all such support structures.

The illustrated apparatus 10 includes a frame 2 (also called a “bracket” or “magnetic carrier” or “angled section” herein) such as plastic. The plastic preferably does not inhibit magnetic flux lines of magnets 3. The illustrated angled frame 2 is L-shaped with two legs forming a 90 degree angle, one of which carries magnets 3 and serves as a mount for engaging a base plate 11 (FIG. 1) or base 1, with the other leg forming a protective mini-barrier. However, a scope of the present invention is contemplated to include other shapes.

The plurality of magnets 3 are attached on one of the sides of the frame 2 at spaced apart locations that are slightly inboard of the section's edge. They can be embedded partially into the frame or can be surface-attached to the frame. The illustrated exposed magnets 3 are rare earth magnets having sufficient strength to securely hold hooks 5A of a fishing lure 5. A strength of the magnets 3 and their spacing allows the lures 5 to be manually attached and detached by a fisher for safety and convenience. A fisher can literally hold his/her lure close to the magnets, and the magnets will magnetically draw in and engage the hooks, holding them in a non-tangling manner. Also, the fisher can literally grip a lure and give a slight tug to release the selected lure, with adjacent lures having their hooks held away in non-tangling locations.

Notably, the magnetic field of the magnets 3 extends through the frame 2, such that the frame 2 can be attached magnetically directly to any magnetically-responsive metal base 1, such as to boat hull 1 (or console, or console lid, or fishing box, or seat back, or other structural support), or to base plate 11 attached to a boat hull (or other structural support).

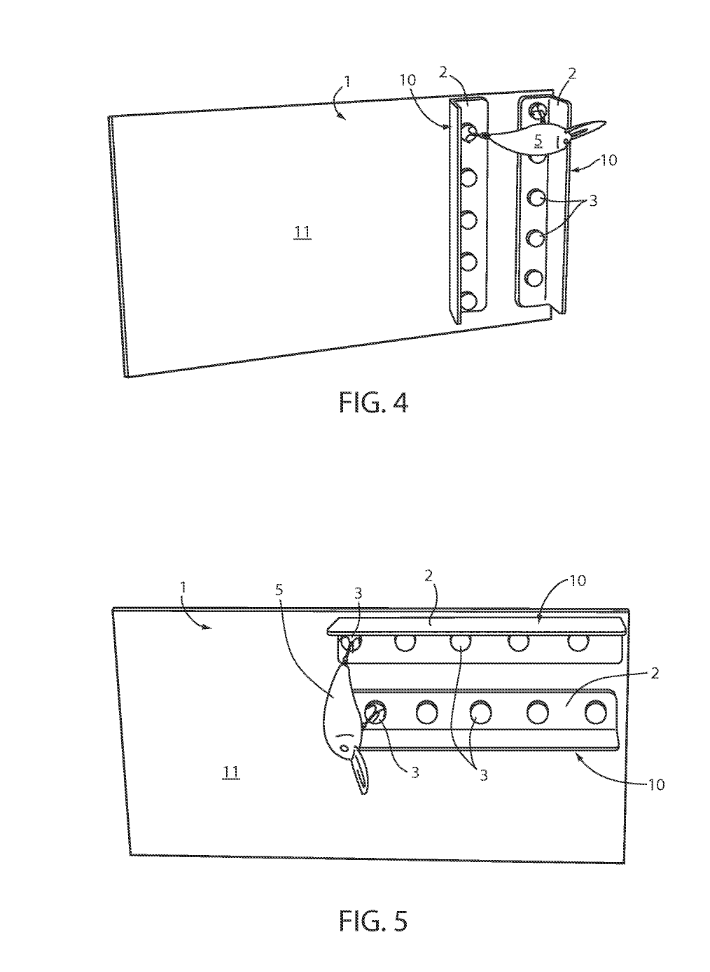

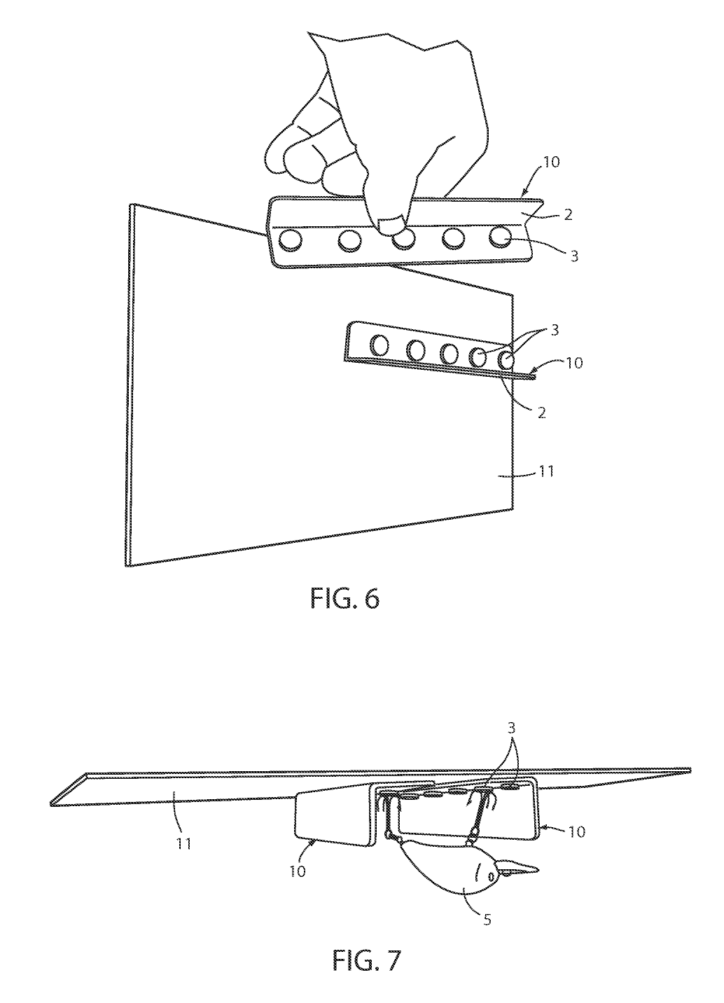

The fact that the apparatus 10 magnetically attaches to a magnetically-responsive base 1 or base plate 11 allows the apparatus 10 to be easily removed, adjusted, and repositioned. By using a base 1 or base plate 11 of metallic sheet metal, the angled section 2 is adjustably positionable, allowing the exposed magnets 3 to be attached at optimal locations depending on the needs and preferences of the fishers using it. For example, the apparatus 10 can be positioned anywhere on the base plate 11 (compare FIGS. 1 and 4), and can be positioned vertically (see FIGS. 1, 4, and 8) or horizontally (see FIG. 5) or upside-down (see FIG. 7) or right-side up (see FIG. 9). FIG. 6 shows an adjustability of the present apparatus, with one holder 10 being adjusted to a desired spacing from another holder 10. By being able to adjust and space the apparatus 10 in any spaced configuration, the fisher is able to space the units in the exact dimension required to best accommodate multiple hooks 5A on one lure 5 using two magnets 3 in the apparatus 10. (See FIG. 7.) As lures are all different lengths and sizes, the use of two magnets 3 in apparatus 10 overcomes a problem where a fixed set of holders might accommodate the correct spacing for only one size lure. When attached, the magnets 3 prevent the hooks 5A from getting tangled with each other and/or from the hook's barbs engaging a sleeve or clothing or other item (including the fisher's finger or hand).

As noted above, the illustrated frames 2 are L-shaped and each include legs 2A and 2B that provide advantages. The leg 2A carries the embedded spaced-apart magnets 3, with the magnet's poles sufficiently exposed to allow the magnets 3 to both retain lure hooks 5A and also to allow the magnets 3 to securely retain the frame to base plate 11 or base 1. The leg 2B provides a shielding function so that the magnetically-held lure hooks 5A are partially protected laterally. The two legs 2B can be positioned to form a protected recess between them with the magnets all being between the two outboard legs 2B. This allows access to the fishing lure 5, from right or left directions, with other directions being partially blocked. Notice that a lip portion of the illustrated Rapala® lure 5 hangs over the leg 2B, thus providing “extra room” for the lure.

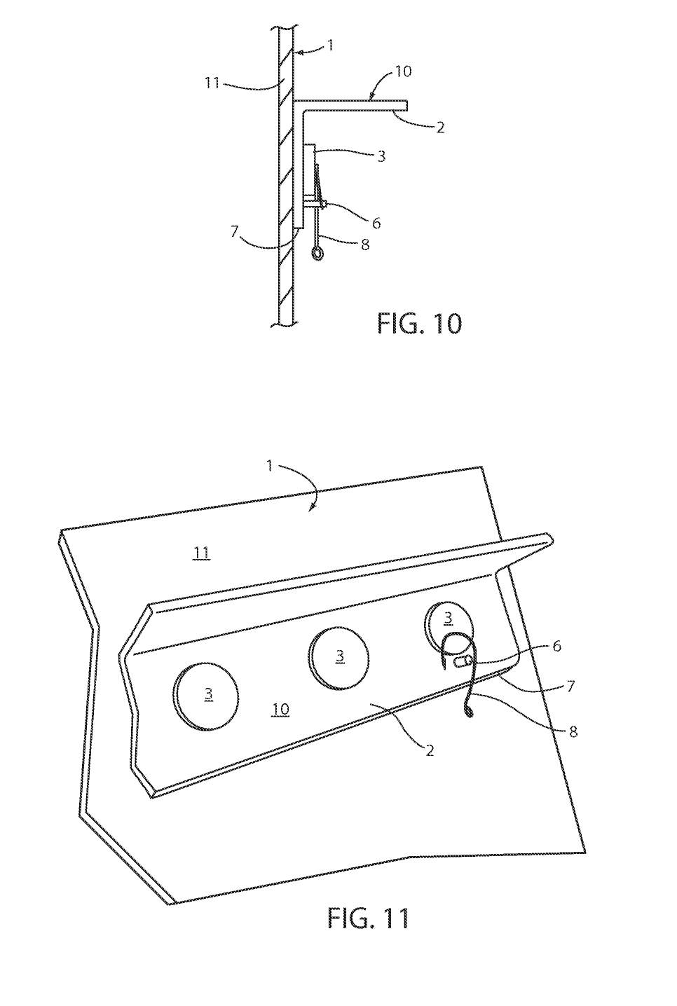

A modified angled section 2 (FIGS. 10-11) includes a small post 6 positioned inboard but near an edge 7 of the leg 2A of the frame 2, at a location just off an edge of the adjacent magnet. A small post 6 has a height extending at least as high as the magnet's outer surface, and preferably to a slightly greater height. This is useful for single-hooked lures such as spinnerbaits and large jigs. The small post 6 extends out past the magnet 3 to provide a catch for the bend of single hook 8. Thus, the single hook 8 cannot laterally slide off of the surface of the magnet 3, since the post 6 will engage the hook 8 and prevent further sliding movement that would allow the hook 8 to move beyond the magnetic retention force of the magnet. Thus, the post 6 prevents accidental disconnection. Notably, the single hook 8 can be placed on the magnet 3 in a flat position relative to an outer face of the magnet 3. Thus, if a force would pull down on the hook 8, such as bouncing from waves while the boat is in motion, the post 6 would catch and stop the hook 8 from sliding/falling off the magnet 3 since the post 6 keeps the hook 8 within the magnetic flux lines that hold the hook 8 on the magnet 3.

Additional modified forms of the present apparatus are disclosed below. Similar and identical features, aspects, and characteristics are described using the same numbers, but with an additional letter such as “A”, “B” or the like. This is done to reduce redundant discussion.

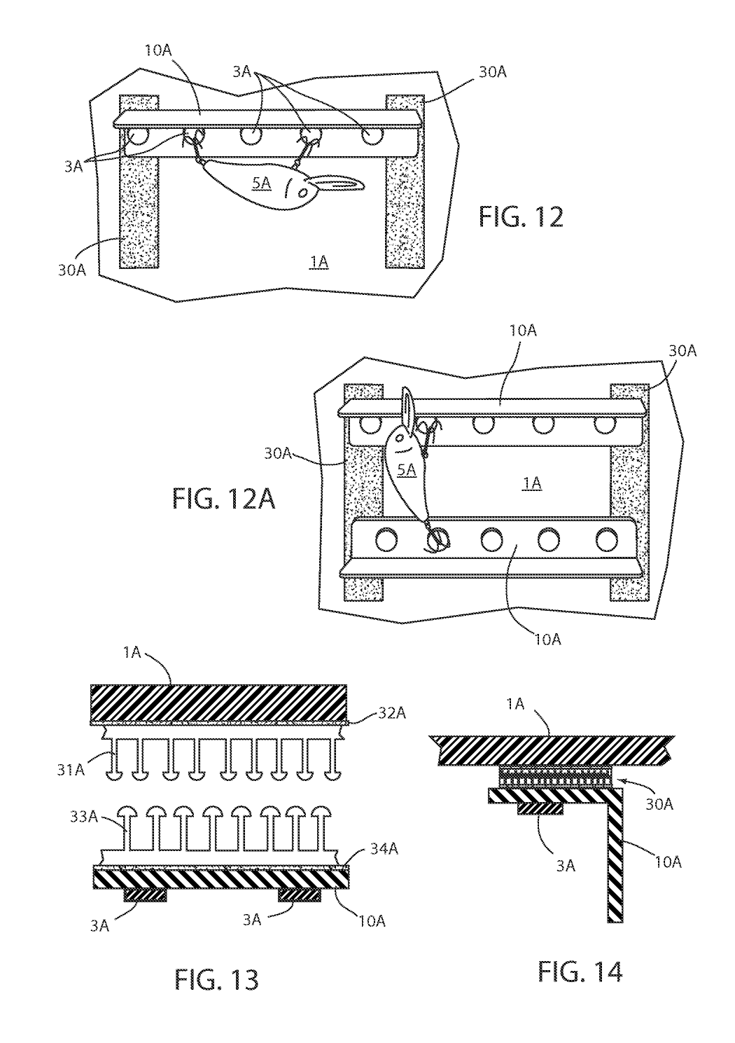

FIG. 12 is a front view of another modified fishing lure holder apparatus 10A, where the L-shaped holder is secured to a base plate 1A by a vertical strip of hook-and-loop material 30A, such as Velcro® material. FIG. 12A is similar to FIG. 12, but illustrates two spaced-apart vertical strips of hook-and-loop material 30A being used to selectively mount a pair of lure-holder apparatuses 10A to the base 1A. FIG. 13 is enlarged to show hook-and-loop material that includes a first portion 31A adhered to the base plate 1A by double-sided sticky tape 32A, and a second portion 33A adheres to the lure holder apparatus 10A by double-sided sticky tape 34A. It is contemplated that a variety of different hook-and-loop materials can be used in combination with the present apparatus 10. However, a particularly effective hook-and-loop material is shown in FIG. 13 and includes a plurality of stems 35A with inverted mushroom-shaped heads 36A that releaseably engage opposing heads 36A. The heads 36A interengage to provide secure and solid retention, but also have a characteristic of being resistant to being plugged with debris and matter often encountered when fishing (such as grass, seaweed, and fishing line).

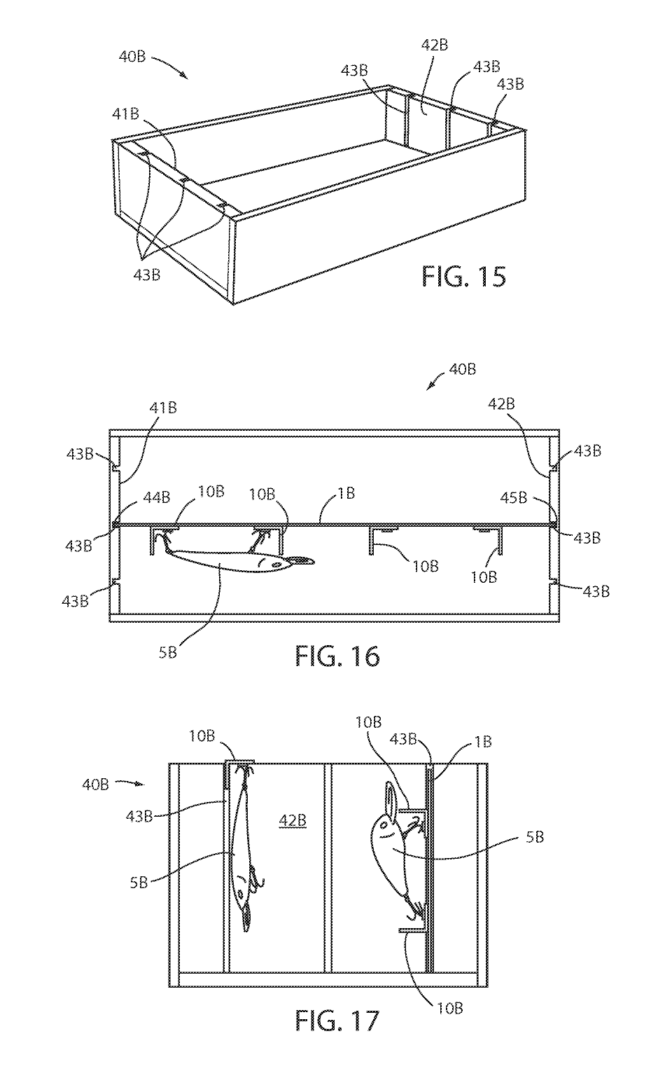

The present apparatus 10 opens up new opportunities for storage. For example, a fishing tackle box 40B (FIG. 15) includes opposing walls 41B, 42B defining a cavity, with slots 43B in a top edge of each wall 41B and 42B. A base plate 1B includes edges 44B and 45B defining a dimension generally equal to the dimension between the edges 44B and 45B. Thus, to store the base plate 1B with lure holders 10B and lures 5B attached, the edges 44B and 45B of the base plate 1B are fit matably releasably into the slots 43B in the walls 41B and 42B. FIG. 16 is a top view showing the tackle box 40B of FIG. 15 with the base plate 1B and lure holding apparatus 10B positioned in one pair of the slots 43B.

FIG. 17 further illustrates that the lure holding apparatus 10B can be directly supported in a pair of the slots 43B in the tackle box 40B without the need for the base plate 1B.

It is to be understood that variations and modifications can be made on the aforementioned structure without departing from the concepts of the present invention, and further it is to be understood that such concepts are intended to be covered by the following claims unless these claims by their language expressly state otherwise.

The invention claimed is:

1. A fishing lure holder comprising:
an elongated magnet-carrying frame with flanges and magnets exposed on one side of the frame to releasably retain lure hooks, the magnets being positioned on the frame so that the magnets attach the frame to an existing magnetically-responsive structure using a magnetic field opposite the one side of the frame having the exposed magnets.

2. The fishing lure holder of claim 1, wherein the flanges include two non-planar flanges.

3. The fishing lure holder of claim 2, wherein the two non-planar flanges form an L-shaped cross section.

4. The fishing lure holder of claim 1, wherein the frame is made of a material that permits magnetic flux to pass therethrough.

5. The fishing lure holder defined in claim 1, wherein the flanges form an L-shaped cross section with one flange partially protecting the magnets on the other flange.

6. The fishing lure holder defined in claim 1, wherein the frame includes a short post adjacent at least some of the magnets that is positioned to keep the lure hook from sliding off one of the magnets.

7. The fishing lure holder defined in claim 1, including a pair of the frames and including a magnetically-responsive base holding the pair of frames at a spaced-apart distances of 1 to 5 inches and including a lure with hooks attached to magnets on each frame.

8. A fishing lure holder comprising:
a frame;
a magnet for holding lure on the frame; and
a small hook catching post adjacent the magnet to stop the hook from sliding off the magnet.

9. The fishing lure holder defined in claim 8, wherein the frame has an L-shaped cross section.

10. The fishing lure holder defined in claim 8, including a the pair of frames and including a magnetically-responsive base holding the pair of frames at a spaced-apart distance of 1 to 5 inches and including a lure with hooks attached to magnets on each frame.

11. A fishing lure holder apparatus for attachment to a metal surface, such as to a fishing boat hull, under a lid on compartment, on console and/or onto a floor, comprising:
at least one L-shaped frame with magnets attached thereto, the magnets being spaced apart and positioned to magnetically hold hooks on a lure for releasable attachment for safety and convenience, with a magnetic field of the magnets passing through the angled section so that the magnetic field securely but releasably attaches the frame to a magnetically-responsive metal base, thus allowing the holder to be removed and repositioned for personal convenience and preference.

12. The apparatus defined in claim 11, wherein the at least one L-shaped frame includes a pair of the L-shaped frames; the pair being adjustable for selective spacing to create a specific dimension that accommodates magnetically holding multiple spaces-apart hooks of one lure.

13. A fishing lure holder comprising:
a pair of frames with magnets located slightly inboard from an edge of the frame, the magnets being exposed and spaced apart, allowing hooks of a lure to be attached and detached for safety and convenience; and
a support releasably supporting the frames at a spaced dimension so that the lure having two hooks separated by a distance similar to the spaced dimension can be secured by the two hooks each engaging one of the magnets.

14. The fishing lure holder of claim 14, including a post extending from the angled section at a location between at least some of the magnets and the edge, the post having a tip that extends at least as high as a top surface of the magnets, whereby a fish hook held on the selected magnet cannot laterally slip off the top surface without engaging the tip.

15. A fishing lure holder comprising:
an elongated magnet-carrying frame with magnets arranged thereon to releasably retain lure hooks; and
a support with hook-and-loop material engaging the frame for releasably adjustably holding the frame on a support.

16. An apparatus comprising:
a tackle box having opposing side walls each with wall-associated connectors thereon; and
a lure-holding frame with magnets thereon and including edges configured to releaseably engage the wall-associated connectors.

17. The apparatus defined in claim 16, wherein the wall-associated connectors are slots formed in the side walls.

18. The apparatus defined in claim 16, wherein the lure-holding frame includes an L-shaped frame with the magnets thereon, and further includes a base plate with the L-shaped frame attached to the base plate.

19. The apparatus defined in claim 18, wherein the base plate includes opposing edges forming elongated blade-like edges shaped to slip into the wall-associated connectors, the connectors being slots that are vertically open and configured to slidingly received the blade-like edges.
